(19) United States
(12) Patent Application Publication
(10) Pub. No.: US 2015/0178868 A1
(43) Pub. Date: Jun. 25, 2015

(54) Child Custody Management System

(71) Applicant: Victoria Boroveeva, Manalapan, NJ (US)

(72) Inventor: Victoria Boroveeva, Manalapan, NJ (US)

(21) Appl. No.: 14/556,743

(22) Filed: Dec. 1, 2014

Related U.S. Application Data
(60) Provisional application No. 61/917,966, filed on Dec. 19, 2013.

(51) Int. Cl. G06Q 50/18; G06Q 10/10

(52) U.S. Cl. CPC G06Q 50/18; G06Q 10/1095

(57) ABSTRACT

A website is designed to facilitate visitation arrangements in contentious custody situations. A third party account is established at the website with an access right for both parents. The website provides a functionality of creating an individual calendar for each child at the third party account, allowing each parent to access the account and the calendar, and put in a request with alternatives for pick up, drop off and/or visitation dates. The non-requesting parent is then able to pick one of the alternatives, and the website will forward the selected date to the requesting parent. Requests and other communications between the parties are done by website-generated e-mails to avoid direct communications and confrontations between the parents.

### REFERENCE TO RELATED APPLICATION

This application claims the benefit of the filing date of Provisional Patent Application No. 61/917,966, filed Dec. 19, 2013.

### BACKGROUND OF THE INVENTION

The present invention generally relates to the field of methods for managing visitations and other custodial responsibilities in adversarial child custody situations.

Several systems for managing custodial responsibilities are currently known.

WO 2009/038573 discloses a method creating a custody order and custody calculation comprising: inputting general background information relating to the parent and child for whom custody is to be shared; calculating a custody percentage between the respective parents based upon a plurality of criteria; generating a Court Order relating to custody; and generating a custody calendar for the parents. This system is primarily designed to calculate a custody percentage and to generate a calendar based on this percentage.

U.S. Patent Publication No. 2004/0133440 discloses a computer-based interactive system that provides tools for divorced parents to manage their parenting responsibilities such as custody arrangements, visitation, child support, and shared medical expenses. With the system of this invention, parents can share information about schedules, documents, activities and bills via their own secure, personalized website. This invention also facilitates the assistance to them by attorneys, counselors, and employers. This invention addresses the needs of all those associated with parenting and divorce and may be available to users according to various service levels. This system is very cumbersome and provides services for divorced parents to manage visitations, child support, medical expenses and much more.

U.S. Pat. No. 7,949,554 discloses a method, system and a computer program for calendar-based coverage monitoring. According to one aspect, a method includes receiving a coverage rule defining multiple covering entities for performing an activity for a covered entity and at least one period of time during which the multiple covering entities is to perform the activity. Individual calendars for the multiple covering entities are monitored and a change in one of the calendars is detected. It is then determined whether the change causes the coverage rule to be violated, and in response to determining that the change causes the coverage rule to be violated, a notification indicating violation of the coverage rule is generated. This system necessitates a monitoring component or person who determines if the “coverage rule” has been violated.

### SUMMARY OF THE INVENTION

The custody management system designed in accordance with the present invention is very different from the ones referenced above.

While the previously-known websites aim to provide communication and information about children for divorced couples with children, the presently disclosed system deals with parents who not only have gone through a very rough divorce, but also where one of the parties is a victim of domestic violence and/or has a restraining order against the other party. Thus, the present system is primarily targeted for domestic violence victims in an attempt to provide protection to those victims who have experienced threat/intimidation/harassment from his/her ex, but where the visitation arrangements for children still have to be made.

In one of its aspects, the invention is a website designed to facilitate visitation arrangements in contentious custody situations. A third party account is established at the website with an access right for both parents. The website provides a functionality of creating an individual calendar for each child at the third party account, allowing each parent to access the account and the calendar, and put in a request with alternatives for pick up, drop off and/or visitation dates. The non-requesting parent is then able to pick one of the alternatives, and the website will forward the selected date to the requesting parent. Requests and other communications between the parties are done by website-generated e-mails to avoid direct communications and confrontations between the parents.

The system is mainly a tool for setting up children visitations (i.e., pick up time and location, drop off time and location, etc.). This system acts as a third party tool to make visitation arrangements between the two conflicting parties. According to the preferred embodiment, the system does not allow any direct communication between the divorced persons, it only enables them to make visitation arrangements of their children, preferably via a web form and emails from the website incorporating the system. These emails are strictly preset on the website and will inform a user when the other party has requested a visitation arrangement, when changes were made to a pending visitation arrangement, and when a visitation request has been approved or denied.

Accordingly, the website offers no communication bridges between the two parties making the arrangements, except creating and managing such visitation arrangements. The main purpose of this website is to protect domestic violence victims from being harassed or intimidated by the offending party, while still enabling its users to effectively arrange visitations for kids via a neutral party's website.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTIONS OF THE DRAWINGS

FIG. 1 depicts an exemplary “Management Visitations Page” of a website implementing the child custody management system of the present invention;

FIG. 2 depicts an exemplary website “Propose New Visitation Arrangement Page” accessible from the “Manage Visitations Page”;

FIG. 3 depicts an exemplary website “Visitation Arrangements Pending Approval Page” accessible from the “Manage Visitations Page”;

FIG. 4 depicts an exemplary website “Change Pending Visitation Arrangement Page” accessible from the “Visitation Arrangements Pending Approval Page”;

FIG. 5 depicts an exemplary website “Approved Visitations Pending Pickup and/or Drop Off Page” accessible from the “Manage Visitations Page”;

FIG. 6 depicts an exemplary website “Visitation Arrangement Details Page” accessible from the “Approval Visitations Pending Pickup and/or Drop Off Page”;

FIG. 7 depicts an exemplary website “Manage Pickup/Drop Off Locations Page” accessible from the “Manage Visitations Page”;

FIG. 8 depicts an exemplary website “Manage Children Information Page” accessible from the “Manage Visitations Page”;

FIG. 9 depicts an exemplary website “Visitations Arrangements History Page” accessible from the “Manage Visitations Page”;

FIG. 10 is an exemplary flowchart of one embodiment of the User Registration process for the child custody management system of the present invention;

FIG. 11 is an exemplary flowchart of one embodiment the child visitation arrangement process of the present invention; and

FIG. 12 depicts an exemplary “User Registration Page” used in the user registration phase of the child custody management system.

### DETAILED DESCRIPTION OF THE PREFERRED EMBODIMENT

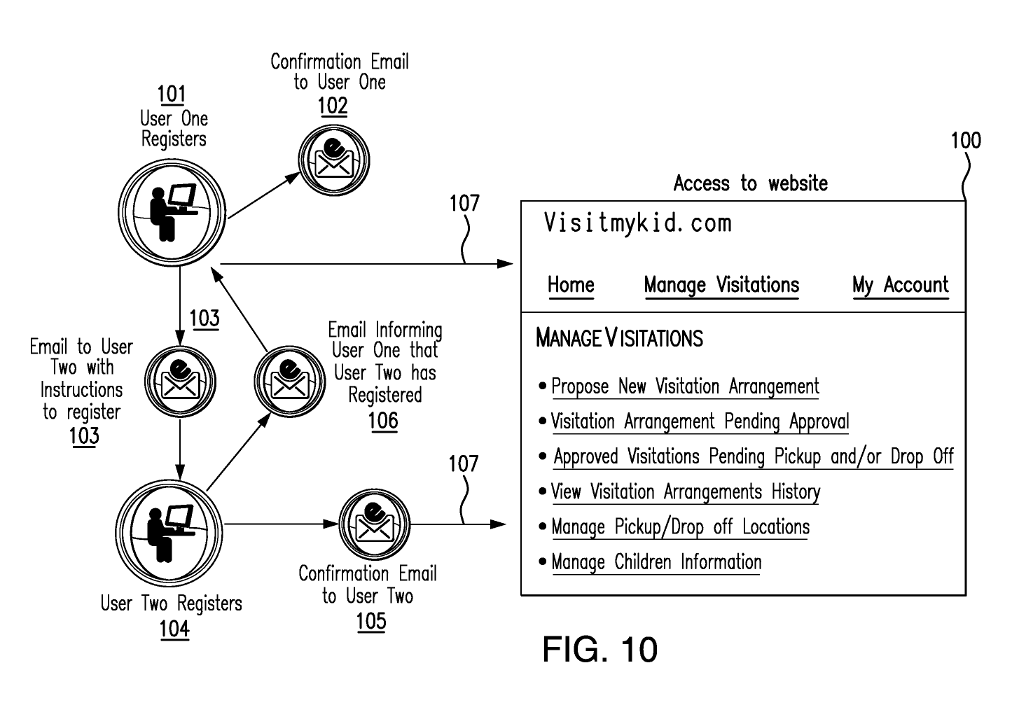

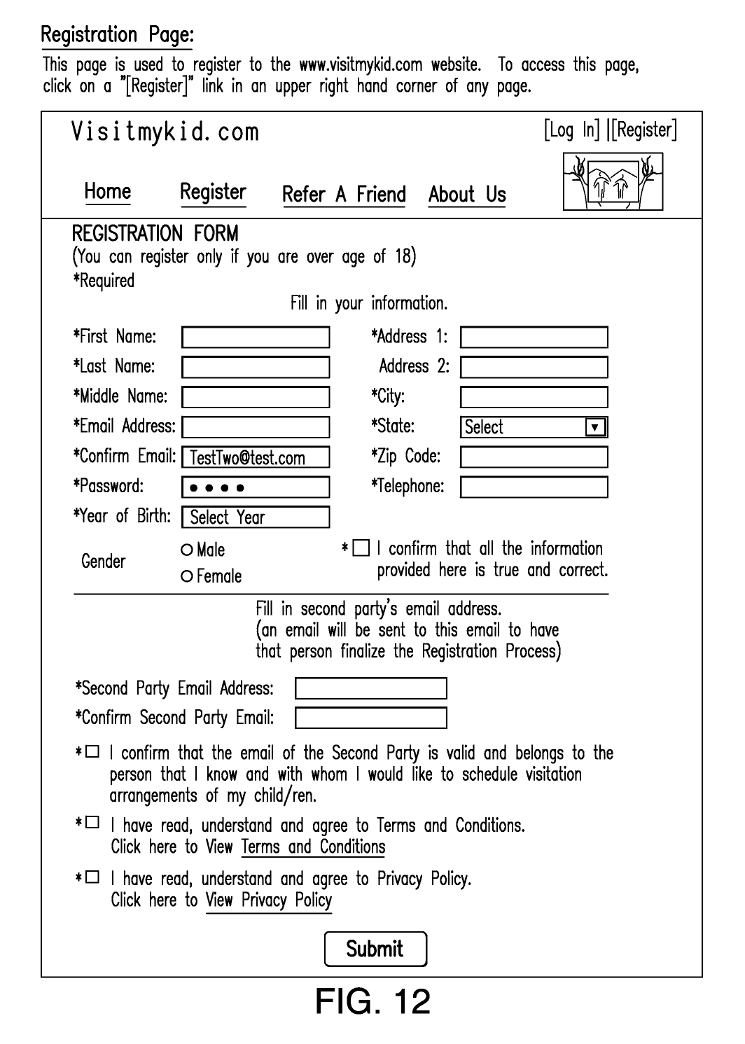

One embodiment of the child custody management system of the present invention begins with a User Registration process, as illustrated by the flowchart of FIG. 10. Upon initial visit to the VisitmyKid.com website 100, the non-custodial parent, referred to as User One, is required to register 101, using the Registration Form depicted in FIG. 12. In the registration 101, User One provides a contact e-mail address and an access password, as well as a contact e-mail for the custodial parent, referred to as User Two.

Upon completion of the registration of User One 101, the website 100 sends a confirmation e-mail to User One 102 and an e-mail to User Two with instructions for User Two to register 103. When User Two completes his/her registration 104, the website sends a confirmation e-mail to User Two 105 and an e-mail informing User One that User Two has registered 106. At this point, both User One and User Two are given password-protected access to the website 107.

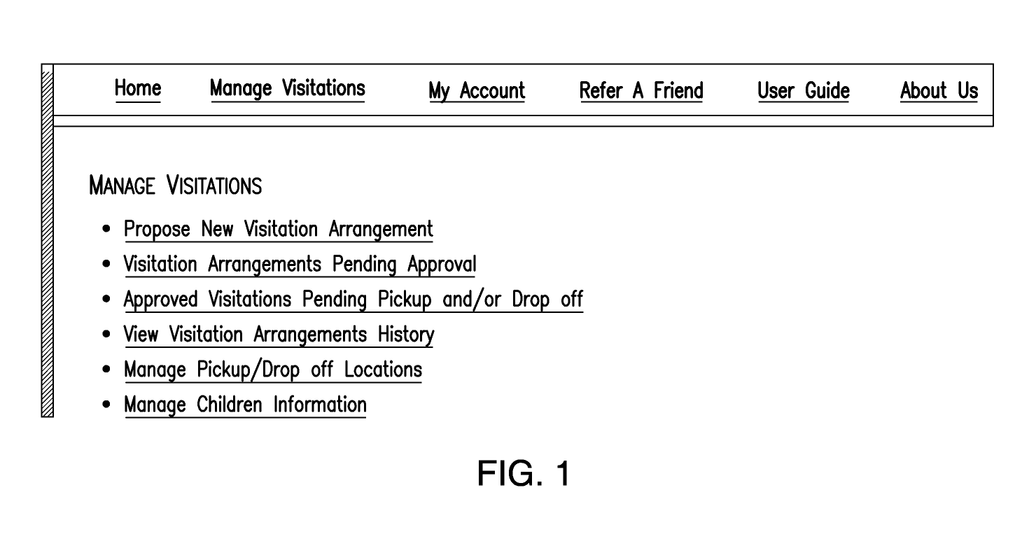

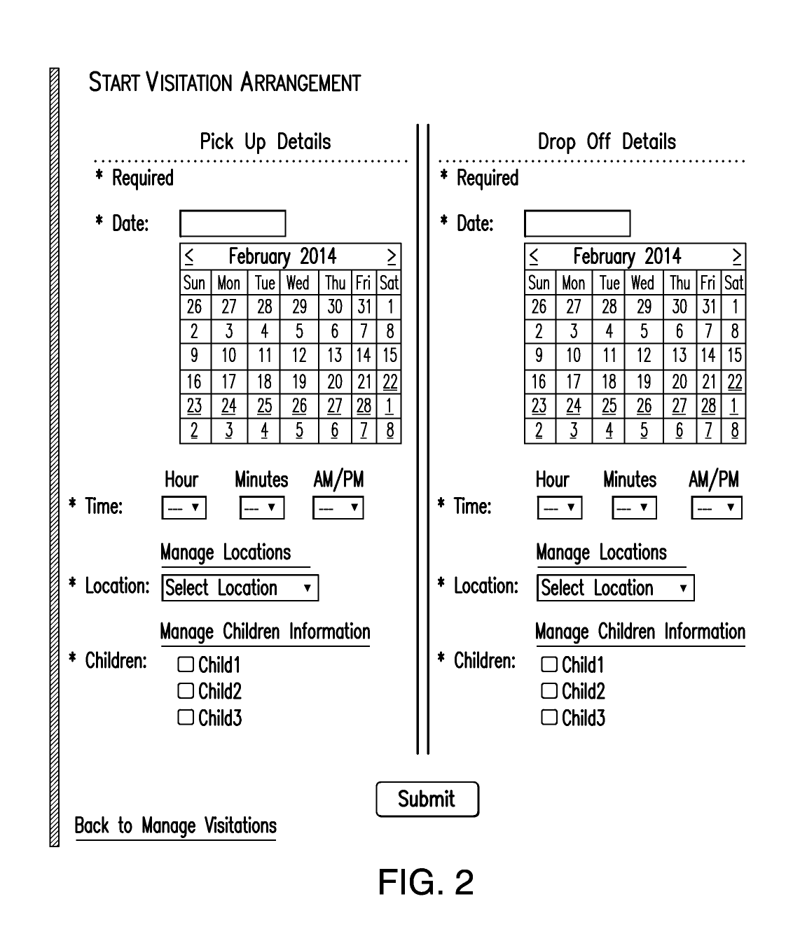

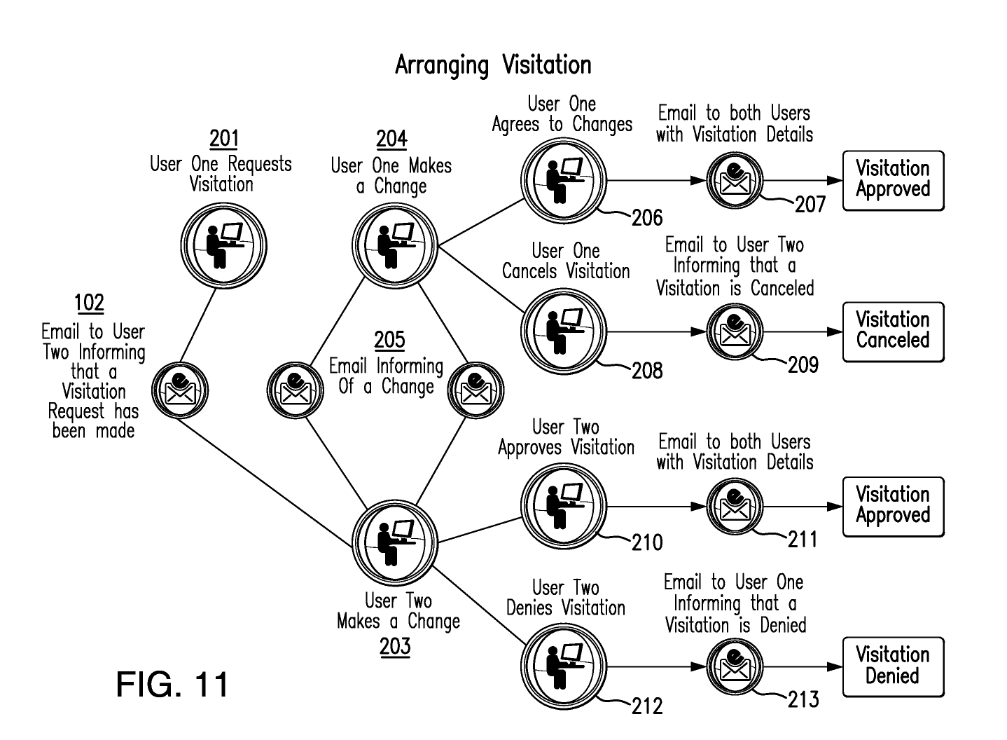

An exemplary process for arranging a child visitation with the non-custodial parent (User One) is illustrated by the flowchart depicted in FIG. 11. User One requests a visitation 201 by accessing the website's “Manage Visitations” page, depicted in FIG. 1, and selecting the “Propose New Visitation Arrangement” link, which takes User One to the “Propose New Visitation Arrangement” page, depicted in FIG. 2. Here User One identifies the child with whom visitation is requested and proposes a date, time and location for pick up and drop off. Upon submission of User One's request, 201, the website 100 sends an e-mail to User Two informing User Two of the visitation request 202.

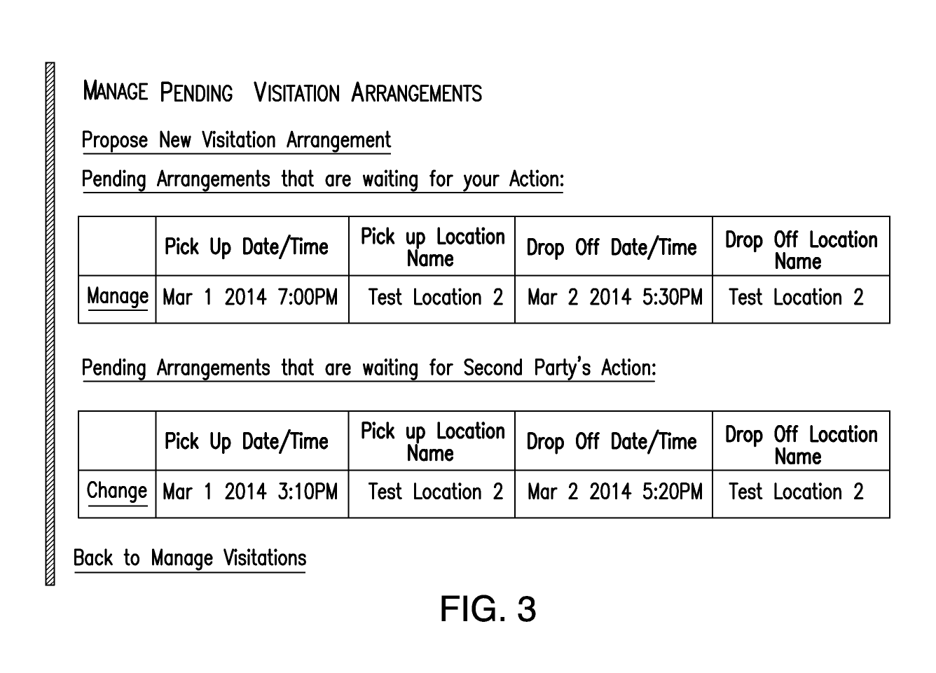

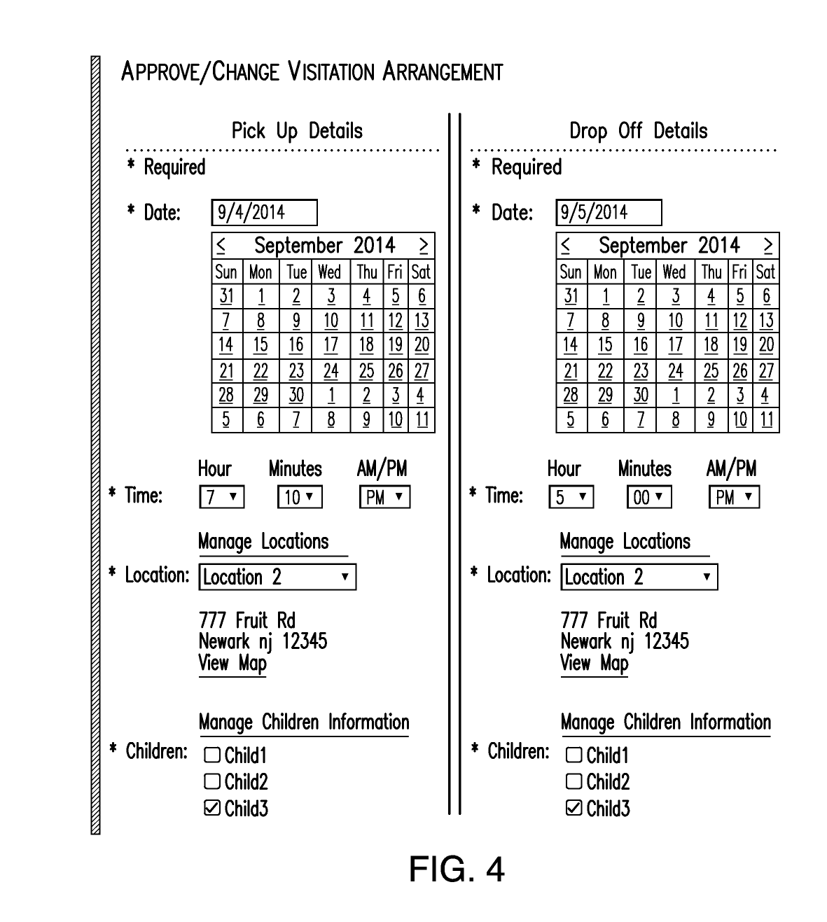

After User One's visitation request 201 is submitted, either user can access, from the link provided on the “Manage Visitations” page (FIG. 1), the “Visitation Arrangements Pending Approval” page, as depicted in FIG. 3. From this page, User Two can request changes in the proposed visitation 203, as can User One 204, by activating a link that takes them to the “Approve/Change Visitation Arrangement” page, depicted in FIG. 4. Upon such a change request being submitted, the website 100 sends an e-mail to the other user 205 informing them of the change.

From the “Approve/Change Visitation Arrangement” page (FIG. 4), User One can agree to changes to the visitation proposed by User Two 206, in which case the website 100 sends a confirming e-mail to both users 207 containing the visitation details. Alternately, from this page User One can cancel the visitation 208, in which case the website 100 sends an e-mail to User Two 209 informing him/her that the visitation is cancelled.

From the “Approve Change Visitation” page (FIG. 4), User Two can approve the visitation as proposed by User One 210, in which case the website 100 sends a confirming e-mail to both users 211 containing the visitation details. Alternately, from this page User Two can deny the proposed visitation 212, in which case the website 100 sends an e-mail to User One 213 informing him/her that the visitation is denied.

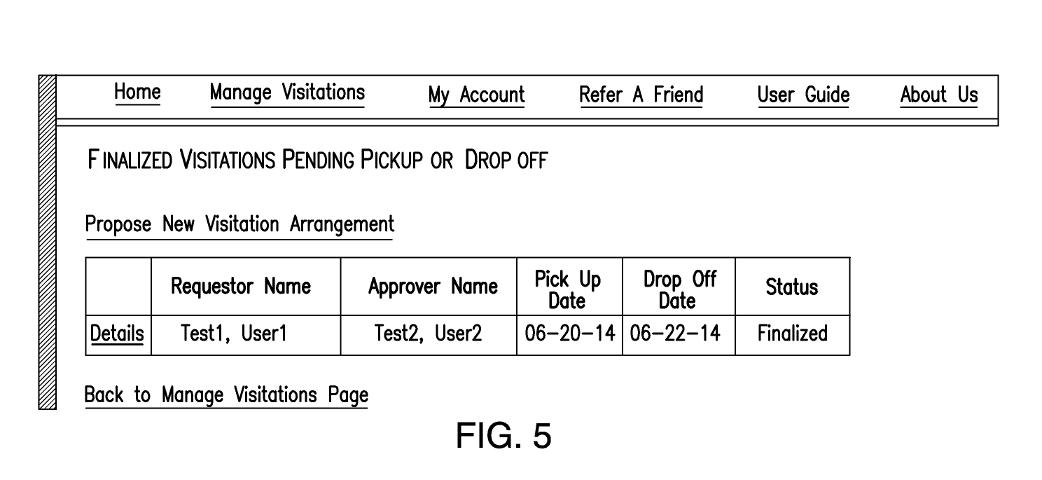

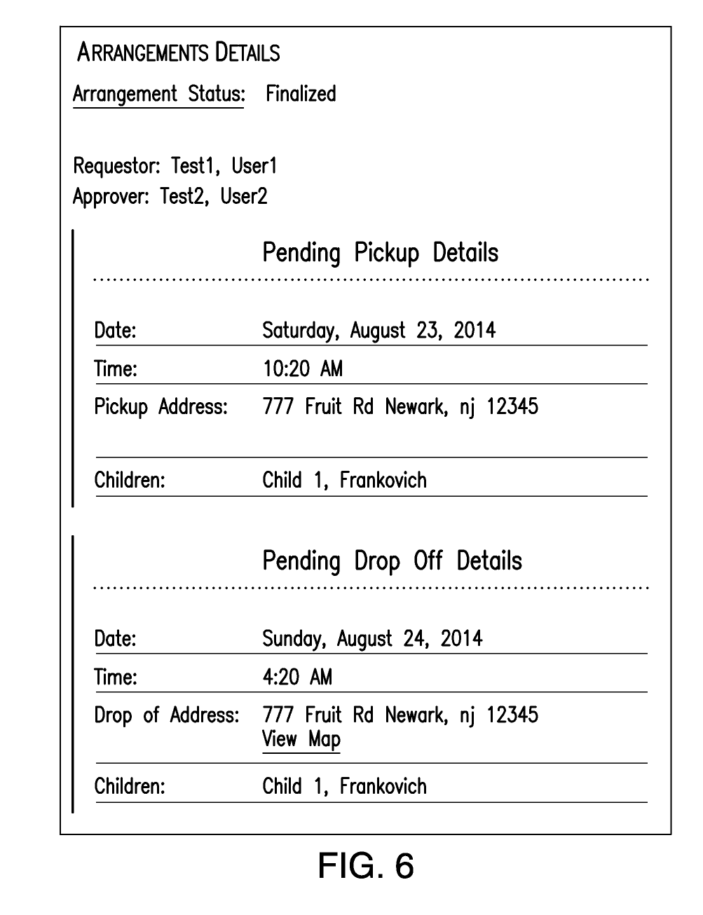

From the “Manage Visitations” page (FIG. 1), either user can activate the link to the “Approved Visitations Pending Pickup or Drop Off” page, depicted in FIG. 5. A link on the latter page takes the user to the “Visitation Arrangements Details” page, depicted in FIG. 6, which lists the time, date and location for both Pickup and Drop Off.

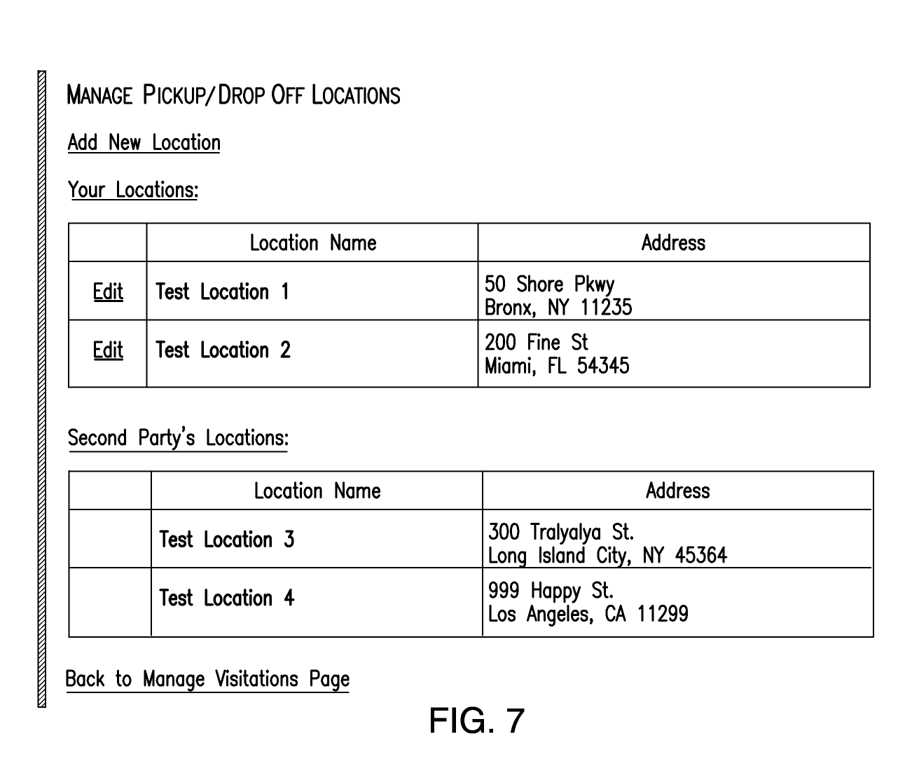

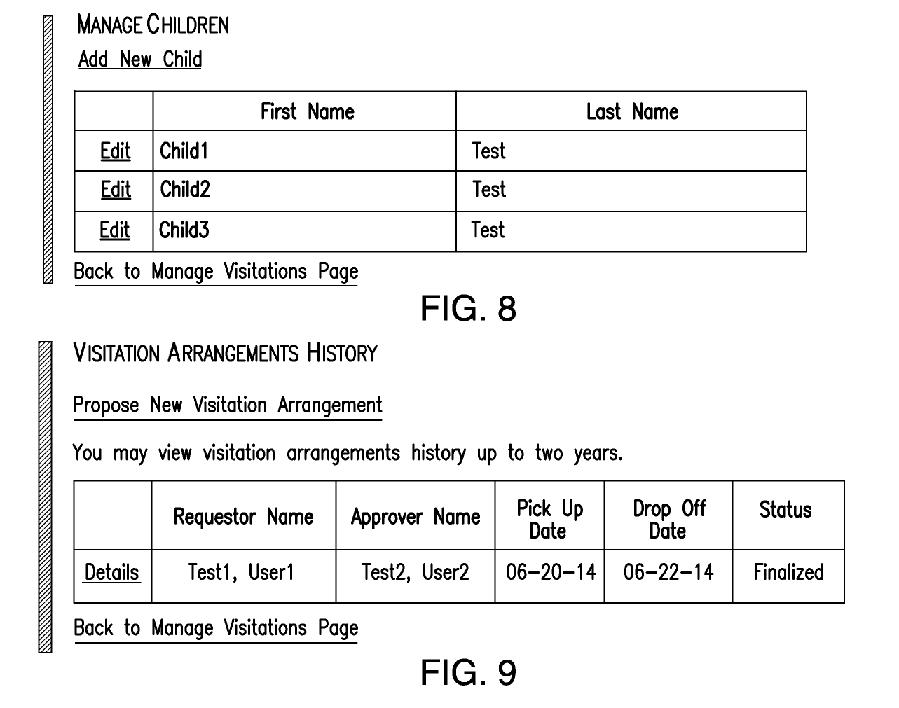

From the “Manage Visitations” page (FIG. 1), either party, by activating the appropriate links, can also manage Pickup and Drop Off locations (FIG. 7), Childrens' Information (FIG. 8) and/or access a History of Visitation Arrangements (FIG. 9).

The foregoing description of the specific embodiments so fully reveals the general nature of the invention that others can, by applying knowledge within the skill of the relevant art(s), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above described exemplary embodiments, but should be defined only in accordance with the claims and their equivalents.

What is claimed is:

1. A method for scheduling parental visitations with one or more child(ren) of two divorced parents, one of whom is a custodial parent, and the other of whom is a non-custodial parent, the method comprising the following steps:
(a) providing a visitation website which enables the divorced parents to arrange one or more parental visitations without enabling direct communication between the divorced parents;
(b) providing the divorced parents with password protected access to the visitations website;
(c) the non-custodial parent accessing the visitations website and submitting a proposed visitation arrangement;
(d) the visitations website sending the custodial parent an e-mail notification of the proposed visitation arrangement;
(e) the custodial parent accessing the visitations website and either indicating an approval of the proposed visitation arrangement or requesting one or more changes to the proposed visitation arrangement so as to submit a first modified visitation arrangement;
(f) the visitations website sending the non-custodial parent an e-mail notification of either the custodial parent's approval of the proposed visitation arrangement, or the first modified visitation arrangement;
(g) if the non-custodial parent is notified of the first modified visitation arrangement, the non-custodial parent accessing the visitations website and either effecting a cancellation of the proposed visitation arrangement, or indicating an approval of the first modified visitation arrangement, or requesting one or more changes to the first modified visitation arrangement so as to submit a second modified visitation arrangement;
(h) the visitations website sending the custodial parent an e-mail notification of either the non-custodial parent's cancellation of the proposed visitation arrangement, or the non-custodial parent's acceptance of the first modified visitation arrangement, or the second modified visitation arrangement;
(i) if the custodial parent is notified of the second modified visitation arrangement, the custodial parent accessing the visitations website and either effecting a denial of the second modified visitation arrangement, or indicating an approval of the second modified visitation arrangement; and
(j) the visitations website sending the non-custodial parent an e-mail notification of either the custodial parent's denial of the second modified visitation arrangement, or the custodial parent's approval of the second modified visitation arrangement.

2. The method of claim 1, further comprising, in step (d), wherein the proposed visitation arrangement specifies one or more child(ren) with whom the parental visitation is sought and also specifies a date, time and location for both a pick up and a drop off of the child(ren).

3. The method of claim 2, comprising the additional step:
(k) the visitations website maintaining password accessible schedules of visitation arrangements pending approval, and of approved visitation arrangements pending pick up or drop off.
